(19) United States
(12) Patent Application Publication
(10) Pub. No.: US 2015/0023496 A1
(43) Pub. Date: Jan. 22, 2015

(54) PAIRING COMPUTATION APPARATUS, PAIRING COMPUTATION METHOD, AND COMPUTER PROGRAM PRODUCT

(71) Applicant: Kabushiki Kaisha Toshiba, Minato-ku (JP)

(72) Inventors: Tomoko YONEMURA, Kawasaki-shi (JP); Ryotaro Hayashi, Hiratsuka-shi (JP); Koichiro Akiyama, Setagaya-ku (JP)

(73) Assignee: Kabushiki Kaisha Toshiba, Minato-ku (JP)

(21) Appl. No.: 14/334,007

(22) Filed: Jul. 17, 2014

(30) Foreign Application Priority Data
Jul. 19, 2013 (JP) 2013-150631

(51) Int. Cl. H04L 9/14

(52) U.S. Cl. CPC H04L 9/14
USPC 380/28

(57) ABSTRACT

According to an embodiment, a pairing computation apparatus receives two points on a predetermined elliptic curve defined on a finite field, and outputs a pairing value that is an element on an extension field of the finite field. The apparatus includes a Miller function computation unit and a final exponentiation unit. The Miller function computation unit is configured to compute a Miller function based on a predetermined pairing method. The final exponentiation unit is configured to perform computation including raising the element on the extension field to the power of a value determined on the basis of a loop parameter of the Miller function.

### CROSS-REFERENCE TO RELATED APPLICATION

This application is based upon and claims the benefit of priority from Japanese Patent Application No. 2013-150631, filed on Jul. 19, 2013; the entire contents of which are incorporated herein by reference.

### FIELD

Embodiments described herein relate generally to a pairing computation apparatus, a pairing computation method, and a computer program product.

### BACKGROUND

Pairing-based cryptography uses mathematical map called pairing, the computation of which involves heavy processing. It is thus desired to accelerate the pairing computation so that the pairing-based cryptography has wider application.

The pairing computation includes a Miller function step and a final exponentiation step. What is computed in the final exponentiation step is an exponentiation on a finite field by a fixed exponent. There is known a method in which an addition chain according to the exponent is determined in advance so that the exponentiation is computed in accordance with the addition chain. This method allows the computation cost of the final exponentiation step to be decreased as Hamming weight of a parameter x used to generate an elliptic curve is decreased.

Now, the pairing-based cryptography processing includes a plurality of pairing computations. A plurality of final exponentiation steps can be computed altogether when the plurality of pairing computations is included. It is however difficult to compute a plurality of Miller function steps altogether. Therefore, it is important to decrease the computation cost of the Miller function step in order to decrease the overall computation cost when the pairing-based cryptography processing includes the plurality of pairing computations.

The computation cost of the Miller function step decreases as Hamming weight of a loop parameter of the Miller function is decreased. However, the Hamming weight of the parameter x is increased as the Hamming weight of the loop parameter of the Miller function is decreased, where it is highly possible that the computation cost of the final exponentiation step increases contrarily. It has therefore been difficult to decrease both the computation cost of the Miller function step and the computation cost of the final exponentiation step.

### BRIEF DESCRIPTION OF THE DRAWINGS

FIG. 1 is a block diagram of a pairing computation apparatus;

FIG. 2 is a diagram illustrating Miller algorithm;

FIG. 3 is a diagram illustrating a polynomial expression representing a loop parameter of a Miller function;

FIG. 4 is a block diagram of a final exponentiation unit;

FIG. 5 is a block diagram of a third exponentiation unit performing exponentiation of {AΦₖ(p)/r};

FIG. 6 is a diagram illustrating algorithm to realize a vectorial addition chain; and

FIG. 7 is a diagram illustrating a hardware configuration of a pairing computation apparatus.

### DETAILED DESCRIPTION

According to an embodiment, a pairing computation apparatus receives two points on a predetermined elliptic curve defined on a finite field, and outputs a pairing value that is an element on an extension field of the finite field. The apparatus includes a Miller function computation unit and a final exponentiation unit. The Miller function computation unit is configured to compute a Miller function based on a predetermined pairing method. The final exponentiation unit is configured to perform computation including raising the element on the extension field to the power of a value determined on the basis of a loop parameter of the Miller function.

Overall Configuration

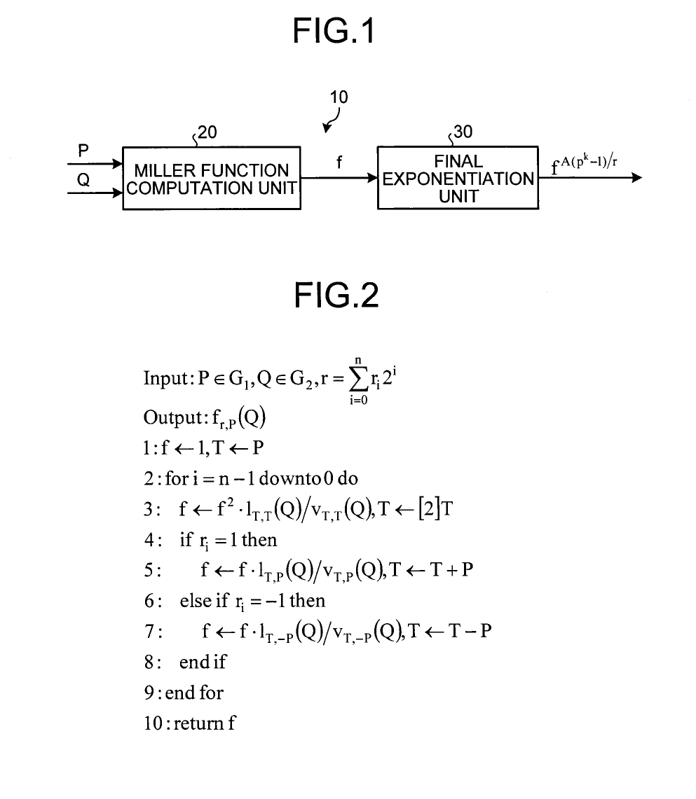

FIG. 1 is a block diagram illustrating the configuration of a pairing computation apparatus 10 of the present embodiment. The pairing computation apparatus 10 is used in processing pairing-based cryptography such as short signature, tripartite key exchange, or ID-based cryptography.

The pairing computation apparatus 10 receives two points P and Q on a predetermined elliptic curve with an order r that is defined on a finite field having a characteristic p. The pairing computation apparatus 10 then outputs a pairing value that is an element on a k-th extension field of the finite field. More specifically, the pairing computation apparatus 10 computes Expression (11) below and outputs the computation result as the pairing value.

f^{A(p}^{^{k}}^{-1)/r} (11)

In Expression (11), f represents the computation involving a Miller function based on a predetermined pairing method. The f represents the computation of a Miller function f_{r,P}(Q) when the predetermined pairing method is a Tate pairing, for example. The f represents the computation of a Miller function f_{p mod r,Q}(P) when the predetermined pairing method is an Ate pairing, for example. The f represents a value obtained by multiplying the computation result of a Miller function f_{c,Q}(P) by a correction term g_{Q}(P), when the predetermined pairing method is an Optimal Ate pairing, for example. In Expression (11), moreover, A represents an integer of 1 or greater. Note that when A=1, the pairing value output by the pairing computation apparatus 10 is identical to the computation result of pairing computation performed in the related art. The value of A will be described later in detail.

The pairing computation apparatus 10 includes a Miller function computation unit 20 and a final exponentiation unit 30.

The two points P and Q on the predetermined elliptic curve are input to the Miller function computation unit 20. The Miller function computation unit 20 then performs computation involving the Miller function based on the predetermined pairing method and outputs the element on the k-th extension field of the finite field as the computation result. In the present embodiment, the Miller function computation unit 20 outputs the outcome obtained by computing the Miller function f_{c,Q}(P) based on the Optimal Ate pairing and multiplying the computation result by the correction term g_{Q}(P). The Miller function computation unit 20 may compute the Miller function based on another pairing method such as the Tate pairing or the Ate pairing.

The final exponentiation unit 30 performs exponentiation, by A(p^{k}−1)/r as an exponent, on the element of the k-th extension field of the finite field that is the computation result by the Miller function computation unit 20. Here, the final exponentiation unit 30 includes exponentiation of the element on the extension field by a value determined on the basis of a loop parameter of the Miller function. The value determined on the basis of the loop parameter of the Miller function is a loop parameter of the Miller function, for example. Moreover, the value determined on the basis of the loop parameter of the Miller function is a value obtained by dividing the loop parameter of the Miller function by a divisor of the loop parameter of the Miller function, for example. Moreover, the value determined on the basis of the loop parameter of the Miller function is a value obtained by multiplying the loop parameter of the Miller function by 2^{l}, where l is an integer. Furthermore, the value determined on the basis of the loop parameter of the Miller function is a value obtained by adding and/or subtracting an integer to/from the loop parameter of the Miller function. Note that the final exponentiation unit 30 will be described later in detail.

The pairing computation apparatus 10 in the present embodiment uses a BN curve or a Freeman curve as the elliptic curve. The pairing computation apparatus 10 may also use an elliptic curve other than the BN curve and the Freeman curve.

The equation of the BN curve used by the pairing computation apparatus 10 in the present embodiment is Y²=X³+b. The BN curve has an extension degree k=12. The extension degree is also referred to as an embedding degree.

Moreover, the BN curve has a characteristic p of a field of definition, or the finite field, that is determined by a polynomial expression of x as in Expression (12) below. The BN curve further has an order r that is determined by a polynomial expression of x as in Expression (13) below. Note that x is an integer of 1 or greater determined such that p and r are both prime numbers.

p=36x⁴+36x³+24x²+6x+1 (12)

r=36x⁴+36x³+18x²+6x+1 (13)

Moreover, the BN curve is expressed as ρ=ceil(log p)/ceil(log r)=1. Note that log X represents the logarithm of X with base 2. The ceil(X) represents computation of rounding up the decimal value of X. The floor(X) to be described represents computation of rounding down the decimal value of X.

Accordingly, ρ=1 indicates that the number of digits when p is represented as a binary number is identical to the number of digits when r is represented as a binary number.

The Freeman curve used by the pairing computation apparatus 10 in the present embodiment has an extension degree k=10. Moreover, the Freeman curve has a characteristic p of a field of definition, or the finite field, that is determined by a polynomial expression of x as in Expression (14) below. The Freeman curve further has an order r that is determined by a polynomial expression of x as in Expression (15) below.

p=25x⁴+25x³+25x²+10x+3 (14)

r=25x⁴+25x³+15x²+5x+1 (15)

Moreover, the Freeman curve is expressed as ρ=ceil(log P)/ceil(log r)=1.

Miller Function Computation Unit 20

FIG. 2 is a diagram illustrating Miller algorithm executed by the Miller function computation unit 20. The Miller function computation unit 20 computes the Miller function by executing the Miller algorithm illustrated in FIG. 2.

In step “Input:”, the Miller function computation unit 20 receives P included in a group G₁, Q included in a group G₂, and r represented as a signed binary expansion. The r is called a loop parameter of the Miller function. In the expression, rᵢ indicates a value in an i-th digit of the r that is represented as the signed binary expansion. The signed binary expansion will be described later.

In step “Output:”, the Miller function computation unit 20 outputs f_{r,P}(Q). The Miller function computation unit 20 executes the step “Output:” after completing steps “1:” to “10:”.

In steps “2:” to “9:”, the final exponentiation unit 30 executes loop processing for each digit of the signed binary representation of r from the highest digit to the lowest digit. Note that i represents the number of digits to be processed.

The Miller function computation unit 20 makes conditional determination of executing processing in step “5:” when rᵢ is 1 in step “4:” of the loop “2:” to “9:”, executing processing in step “7:” when rᵢ is −1, and skipping processings in steps “5:” and “7:” to proceed to next processing when rᵢ is 0.

After completing the loop processing in steps “2:” to “9:”, the Miller function computation unit 20 returns the value of f in step “10:” and completes the processing.

Here, a loop parameter c (=r) of the Miller function is set beforehand to have a minimum Hamming weight when the loop parameter c is represented by binary in the signed binary expansion (signed Hamming weight). That is, the Miller function computation unit 20 computes the Miller function by using the loop parameter c of the Miller function that is set beforehand such that the signed Hamming weight takes a minimum value. Note that the loop parameter c of the Miller function may be set such that the signed Hamming weight takes a value close to the minimum value.

The signed binary expansion is to expand an integer a into an expression representing the total sum of values, each of which is obtained by multiplying a value corresponding to the weight of a digit of a binary number (an i-th power of 2 such as 2⁰, 2¹, 2² and 2³) by a coefficient aᵢ, as in Expression (16) below.

a=a₀2⁰+a₁2¹+a₂2²+ . . . +aᵢ2ⁱ+aₙ2ⁿ (16)

aᵢ=−1,0,1

Note that i is an integer of 0 or greater. The same value corresponding to the weight of the digit of the binary number is not used in duplication.

The coefficient aᵢ in Expression (16) takes any of values −1, 0, and 1.

The signed Hamming weight represents the number of non-zero terms (that is, the number of terms with the coefficient aᵢ equal to −1 or 1) in the signed binary expansion of the integer as described above.

The Miller function computation unit 20 receives, as the loop parameter c of the Miller algorithm, the binary representation of the integer r in the signed binary expansion. The Miller function computation unit 20 can therefore set the sum of the number of digits in which rᵢ is determined to be 1 by the conditional determination in step “4:” and the number of digits in which rᵢ is determined to be −1 by the conditional determination in step “6:” to take a minimum value or a value close thereto. Accordingly, the sum of the number of times step “5:” is executed and the number of times step “7:” is executed by the Miller function computation unit 20 can be set to the least number of times or the number of times close to the least number of times. As a result, the Miller function computation unit 20 can decrease the computation cost of the Miller function.

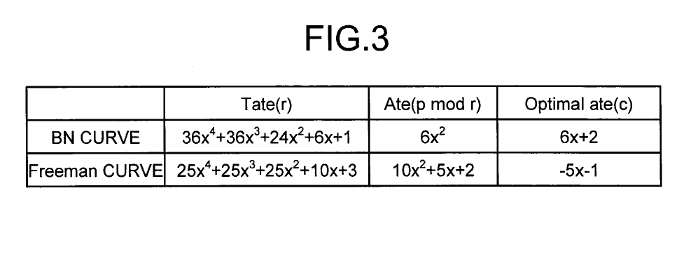

FIG. 3 is a table illustrating a polynomial expression which expresses the loop parameter of the Miller function of each of a Tate pairing, an Ate pairing, and an Optimal Ate pairing in terms of x.

The Miller function computation unit 20 may compute the Miller function with the Tate pairing or the Ate pairing besides the Optimal Ate pairing, for example.

The loop parameter c (=r) of the Miller function equals 36x⁴+36x³+24x²+6x+1 when the BN curve is used in the Tate pairing. The loop parameter c (=r) of the Miller function equals 25x⁴+25x³+25x²+10x+3 when the Freeman curve is used in the Tate pairing.

The loop parameter c (=p mod r) of the Miller function equals 6x² when the BN curve is used in the Ate pairing. Moreover, the loop parameter c (=p mod r) of the Miller function equals 10x²+5x+2 when the Freeman curve is used in the Ate pairing.

Furthermore, the loop parameter c of the Miller function equals 6x+2 when the BN curve is used in the Optimal Ate pairing. The loop parameter c of the Miller function equals −5x−1 when the Freeman curve is used in the Optimal Ate pairing.

Here, when the BN curve is used in the Optimal Ate pairing, the minimum value of the signed Hamming weight of c equals 3 where the number of digits of the binary representation of the order r equals 224 to 287 digits. Table 1 represents the loop parameter c of the Miller function in each of the number of digits 224 to 287 of the binary representation of the order r such that each of the characteristic p and the order r is a prime number and that the signed Hamming weight takes a minimum value 3.

TABLE 1

| ceil(log r) | c(=6x + 2) | p mod 4 |
|---|---|---|
| 224 | −2⁵⁷ −2⁵² +2³ | 3 |
| 226 | 2⁵⁷ +2⁵⁶ −2⁵⁰ | 3 |
| 226 | 2⁵⁸ −2⁵⁶ −2⁵⁰ | 3 |
| 227 | −2⁵⁸ −2³¹ −2⁴ | 3 |
| 227 | −2⁵⁸ +2⁵⁴ −2³⁰ | 3 |
| 227 | −2⁵⁸ +2⁴ +2 | 1 |
| 231 | 2⁵⁹ +2² +2 | 1 |
| 231 | 2⁵⁹ +2³ −2 | 1 |
| 231 | 2⁵⁹ −2⁵¹ −2¹⁸ | 3 |
| 235 | −2⁶⁰ +2²³ −2⁷ | 3 |
| 239 | −2⁶¹ −2²⁶ +2³ | 3 |
| 239 | 2⁶¹ +2³³ −2 | 1 |
| 239 | 2⁶¹ −2⁵³ +2¹¹ | 3 |
| 247 | 2⁶³ −2²⁴ +2⁶ | 3 |
| 247 | −2⁶³ +2⁵³ −2¹⁶ | 3 |
| 247 | −2⁶³ +2²⁵ +2¹⁵ | 3 |
| 251 | 2⁶⁴ +2³⁹ +2¹⁵ | 3 |
| 255 | −2⁶⁵ −2⁴⁴ −2²⁴ | 3 |
| 255 | 2⁶⁵ −2³⁸ −2²³ | 3 |
| 255 | 2⁶⁵ −2⁵⁶ −2⁴¹ | 3 |
| 259 | 2⁶⁶ +2²⁷ +2¹⁹ | 3 |
| 259 | −2⁶⁶ −2⁵⁴ −2³⁵ | 3 |
| 259 | −2⁶⁶ +2²⁶ −2⁶ | 3 |
| 259 | −2⁶⁶ +2⁵⁴ +2²⁵ | 3 |
| 259 | −2⁶⁶ +2⁶³ +2¹⁰ | 3 |
| 263 | 2⁶⁷ +2¹² −2⁶ | 3 |
| 267 | −2⁶⁸ −2⁵² +2¹⁶ | 3 |
| 267 | 2⁶⁸ −2²⁴ +2⁷ | 3 |
| 271 | 2⁶⁹ +2¹² +2⁷ | 3 |
| 271 | 2⁶⁹ −2²⁷ +2¹¹ | 3 |
| 271 | −2⁶⁹ +2⁵⁷ −2³⁴ | 3 |
| 272 | 2⁶⁹ +2⁶⁶ −2²⁶ | 3 |
| 275 | −2⁷⁰ −2⁵⁷ −2²⁸ | 3 |
| 275 | 2⁷⁰ +2⁵⁹ −2⁵⁴ | 3 |
| 279 | 2⁷¹ −2²³ +2¹⁵ | 3 |
| 283 | 2⁷² −2⁵⁸ +2²⁵ | 3 |
| 283 | 2⁷² −2²⁰ −2¹² | 3 |
| 283 | −2⁷² +2³⁷ +2² | 3 |
| 287 | −2⁷³ −2⁴⁴ −2²⁰ | 3 |
| 287 | 2⁷³ −2⁵⁴ +2⁴² | 3 |
| 287 | −2⁷³ +2⁶¹ −2¹⁰ | 3 |

Accordingly, the Miller function computation unit 20 sets the loop parameter of the Miller function to a corresponding value in column c (=6x+2) in Table 1, when the BN curve is used in the Optimal Ate pairing and the number of digits of the binary representation of the order r corresponds to any value in column ceil(log r) in Table 1. The Miller function computation unit 20 can thus have the smallest computation cost of the Miller function when the BN curve is used in the Optimal Ate pairing. Note that “p mod 4” in Table 1 represents a remainder obtained by dividing p by 4.

When the Freeman curve is used in the Optimal Ate pairing, a minimum value of the signed Hamming weight of r equals 4 where the number of digits of the binary representation of the order r equals 224 to 288 digits. Table 2 represents the loop parameter c of the Miller function in each of the number of digits 224 to 288 of the binary representation of the order r such that each of the characteristic p and the order r is a prime number and that the signed Hamming weight takes a minimum value 4.

TABLE 2

| ceil(log r) | c = −5x − 1 | p mod 4 |
|---|---|---|
| 224 | −2⁵⁷ −2¹⁸ +2⁸ −1 | 3 |
| 224 | −2⁵⁷ +2⁵¹ +2³⁷ +1 | 3 |
| 228 | 2⁵⁸ +2⁶ +2⁵ −1 | 3 |
| 228 | −2⁵⁸ −2⁴⁵ +2⁴⁰ −1 | 3 |
| 228 | 2⁵⁸ −2³¹ −2⁸ −1 | 3 |
| 232 | −2⁵⁹ −2⁴⁷ −2¹⁴ −1 | 3 |
| 232 | 2⁵⁹ +2⁵⁴ −2³⁸ +1 | 3 |
| 232 | −2⁵⁹ +2¹³ +2⁴ −1 | 3 |
| 240 | 2⁶¹ +2⁴³ −2³³ +1 | 3 |
| 240 | −2⁶¹ +2⁵³ +2³⁵ +1 | 3 |
| 244 | 2⁶² +2³⁰ +2⁵ −1 | 3 |
| 260 | −2⁶⁶ −2⁶¹ −2³⁶ +1 | 3 |
| 268 | −2⁶⁸ −2²¹ −2⁶ +1 | 3 |
| 268 | −2⁶⁸ +2³³ −2²³ +1 | 3 |
| 268 | −2⁶⁸ +2⁵⁷ −2²⁷ +1 | 3 |
| 276 | 2⁷⁰ +2³⁷ +2⁵ +1 | 3 |
| 288 | 2⁷³ +2⁵⁰ +2³⁴ −1 | 3 |
| 288 | −2⁷³ −2⁶⁶ −2¹⁶ +1 | 3 |
| 288 | −2⁷³ +2⁶⁰ −2³⁴ −1 | 3 |

Accordingly, the Miller function computation unit 20 sets the loop parameter of the Miller function to a corresponding value in column “c (=−5x−1)” in Table 2, when the Freeman curve is used in the Optimal Ate pairing and the number of digits of the binary representation of the order r corresponds to any value in column “ceil(log r)” in Table 2. The Miller function computation unit 20 can thus have the smallest computation cost of the Miller function when the Freeman curve is used in the Optimal Ate pairing. Note that “p mod 4” in Table 2 represents a remainder obtained by dividing p by 4.

Final Exponentiation Unit 30

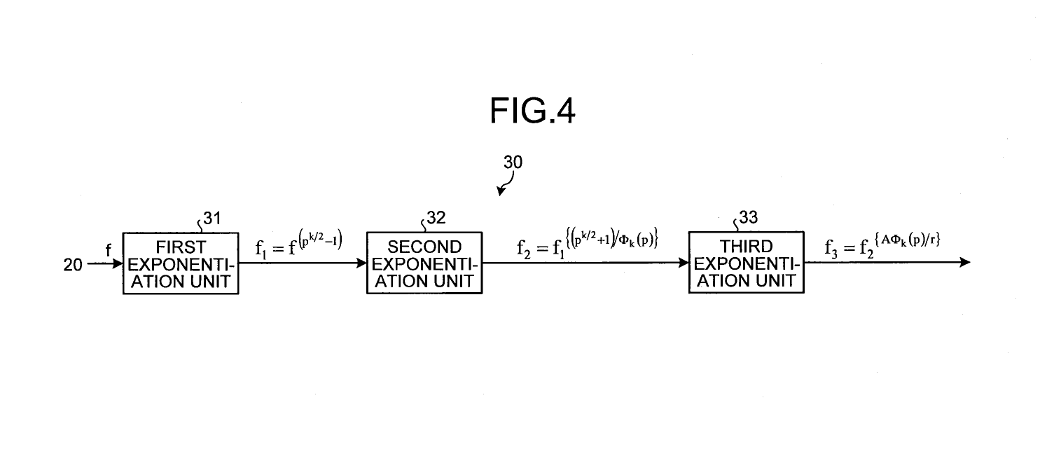

FIG. 4 is a block diagram illustrating the configuration of the final exponentiation unit 30. The final exponentiation unit 30 performs exponentiation, by the exponent A(p^{k}−1)/r, of the element on the k-th extension field of the finite field that is the result computed by the Miller function computation unit 20.

The final exponentiation unit 30 computes the exponent A(p^{k}−1)/r in three parts as in Expression (21) below. Note that Φₖ(p) is a k-th cyclotomic polynomial of p.

$$A \frac{{p}^{k} - 1}{r} = ( {p}^{k / 2} - 1 ) \cdot \{ ( {p}^{k / 2} + 1 ) / {Φ}_{k} ( p ) \} \cdot \{ A {Φ}_{k} ( p ) / r \} \qquad ( 21 )$$

Specifically, the final exponentiation unit 30 includes a first exponentiation unit 31, a second exponentiation unit 32, and a third exponentiation unit 33. The first exponentiation unit 31 performs exponentiation with the exponent (p^{k/2}−1). The second exponentiation unit 32 performs exponentiation with the exponent {(p^{k/2}+1)/Φₖ(p)}. The third exponentiation unit 33 performs exponentiation with the exponent {AΦₖ(p)/r}.

The first exponentiation unit 31, the second exponentiation unit 32, and the third exponentiation unit 33 are connected in series. The first exponentiation unit 31, the second exponentiation unit 32, and the third exponentiation unit 33 may be connected in any order.

The forefront exponentiation unit among the first exponentiation unit 31, the second exponentiation unit 32, and the third exponentiation unit 33 receives the computation result obtained by the Miller function computation unit 20. Each of the second and last exponentiation units performs exponentiation on the computation result of the preceding stage. The last exponentiation unit then outputs a final exponentiation result.

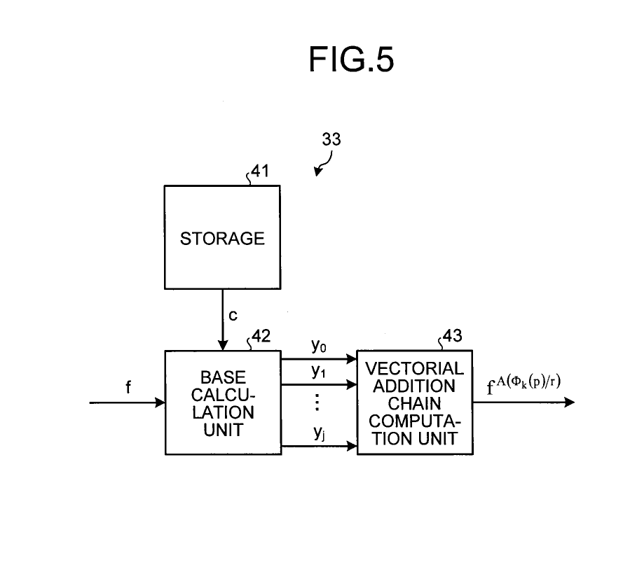

FIG. 5 is a block diagram illustrating the configuration of the third exponentiation unit 33 which performs exponentiation with the exponent {AΦₖ(p)/r}.

The third exponentiation unit 33 includes a storage 41, a base calculation unit 42, and a vectorial addition chain computation unit 43. The storage 41 stores the loop parameter c of the Miller function in advance.

The base calculation unit 42 computes a predetermined expression on an element f of the k-th extension field that is received from the preceding stage, and outputs a plurality of bases y₀, y₁, . . . , yⱼ, where j is an integer of 1 or greater. The predetermined expression includes exponentiation of the element f on the k-th extension field being received, with the loop parameter c of the Miller function stored in the storage 41 as the exponent. Note that the expression computed by the base calculation unit 42 will be described later in detail.

The vectorial addition chain computation unit 43 receives the plurality of bases y₀, y₁, . . . , yⱼ from the base calculation unit 42. The vectorial addition chain computation unit 43 then uses a vectorial addition chain to compute an expression in which all of each of the plurality of input bases y₀, y₁, . . . , yⱼ raised to the power of an integer of 1 or greater are multiplied together. Specifically, the vectorial addition chain computation unit 43 uses the vectorial addition chain to compute Expression (22) below.

f^{A(Φ}^{^{k}}^{(p)/r)}=y₀^{B}^{₀}·y₁^{B}^{₁}· . . . ·yᵢ^{B}^{ᵢ} (22)

In this expression, each of B₀, B₁, . . . , Bᵢ is a predetermined integer of 1 or greater. The vectorial addition chain computation unit 43 thereafter outputs the result of executing the vectorial addition chain as the result of the exponentiation of the element f by the exponent {AΦₖ(p)/r}. Note that the expression computed by the vectorial addition chain computation unit 43 will be described later in detail.

BN Curve

Now, there will be described the expression computed by the base calculation unit 42 and the vectorial addition chain computation unit 43 specifically when the BN curve is used in the Optimal Ate pairing.

The embedding degree of the BN curve is k=12, whereby the k-th cyclotomic polynomial Φₖ(p) is expressed as Expression (23) below.

Φ₁₂(p)=p⁴−p²+1 (23)

Expression (23) is divided by r to obtain Expression (24) below.

$$\frac{{Φ}_{12} ( p )}{r} = \frac{{p}^{4} - {p}^{2} + 1}{r} \qquad ( 24 )$$

The p and r of the BN curve are represented by the polynomial expression of x as expressed in Expressions (12) and (13). Expressions (12) and (13) are substituted for Expression (24), which is then organized to be modified into Expression (25) below.

$$\frac{{Φ}_{12} ( p )}{r} = {λ}_{3} {p}^{3} + {λ}_{2} {p}^{2} + {λ}_{1} p + {λ}_{0} \qquad ( 25 )$$

In Expression (25), each of λ₀, λ₁, λ₂, and λ₃ is set as in Expression (26) below.

$$\{ \begin{matrix}{λ}_{3} = 1 \\ {λ}_{2} = 6 {x}^{2} + 1 \\ {λ}_{1} = - 36 {x}^{3} - 18 {x}^{2} - 12 x + 1 \\ {λ}_{0} = - 36 {x}^{3} - 30 {x}^{2} - 18 x - 2\end{matrix} \qquad ( 26 )$$

Here, the parameter c equals c=6x+2 when the BN curve is used in the Optimal Ate pairing. Each of λ₀, λ₁, λ₂, and λ₃ in Expression (26) is then converted to an expression with the loop parameter c of the Miller function as a variable, as in Expression (27) below.

$$\{ \begin{matrix}{λ}_{3} = 1 \\ {λ}_{2} = ( {c}^{2} - 4 c + 10 ) / 6 \\ {λ}_{1} = ( - {c}^{3} + 3 {c}^{2} - 12 c + 26 ) / 6 \\ {λ}_{0} = ( - {c}^{3} + {c}^{2} - 10 c + 12 ) / 6\end{matrix} \qquad ( 27 )$$

In order for the exponent to have an integer value, each of λ₀, λ₁, λ₂, and λ₃ in Expression (27) is multiplied by 6. Then, there is obtained expression (28) in which the element f on the extension field is raised to the power of the expression using the six-fold λ₀, λ₁, λ₂, and λ₃.

$${f}^{6 \cdot \frac{{Φ}_{12} ( p )}{r}} = {y}_{0} \cdot {y}_{1}^{3} \cdot {y}_{2}^{4} \cdot {y}_{3}^{6} \cdot {y}_{4}^{10} \cdot {y}_{5}^{12} \cdot {y}_{6}^{26} \qquad ( 28 )$$

Each of y₀, y₁, y₂, y₃, y₄, y₅, and y₆ in Expression (28) is set as in expression (29) below.

$$\{ \begin{matrix}{y}_{0} = {( {f}^{{c}^{2}} )}^{{p}^{2}} \cdot {f}^{{c}^{2}} / \{ {( {f}^{{c}^{3}} )}^{p} \cdot {f}^{{c}^{3}} \} \\ {y}_{1} = {( {f}^{{c}^{2}} )}^{p} \\ {y}_{2} = 1 / {( {f}^{c} )}^{{p}^{2}} \\ {y}_{3} = {f}^{{p}^{3}} \\ {y}_{4} = {f}^{{p}^{2}} / {f}^{c} \\ {y}_{5} = f / {( {f}^{c} )}^{p} \\ {y}_{6} = {f}^{p}\end{matrix} \qquad ( 29 )$$

Each of the bases y₀, y₁, y₂, y₃, y₄, y₅, and y₆ has a value according to Expression (29) above when the BN curve is used in the Optimal Ate pairing. That is, when the BN curve is used in the Optimal Ate pairing, the base calculation unit 42 computes Expression (29) to output the bases y₀, y₁, y₂, y₃, y₄, y₅, and y₆.

Note that Expression (29) includes exponentiation f^{c} in which the element f is raised to the power of the loop parameter c of the Miller function.

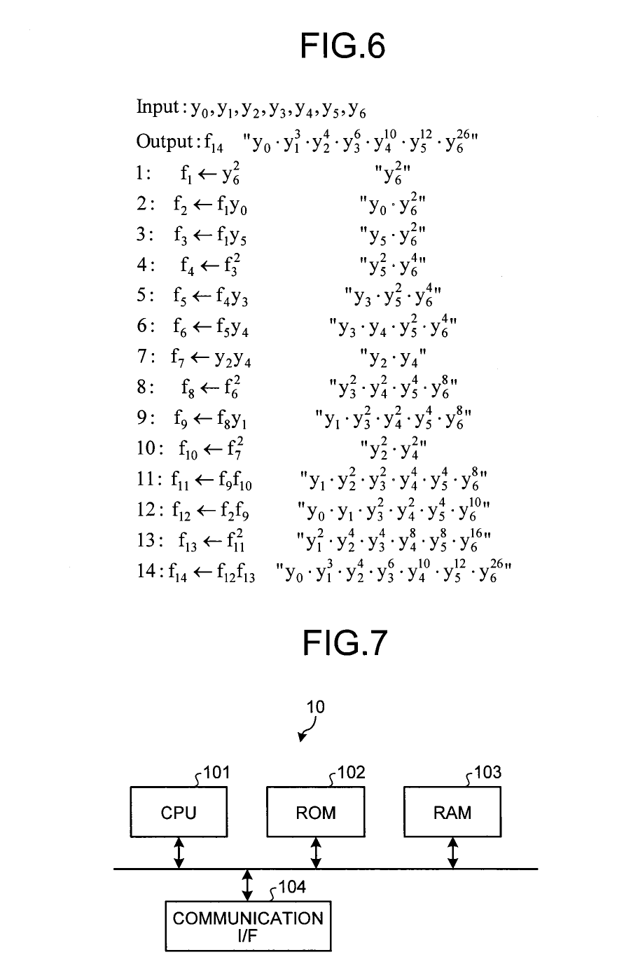

Moreover, when the BN curve is used in the Optimal Ate pairing, the vectorial addition chain computation unit 43 computes Expression (28) by using the vectorial addition chain. The vectorial addition chain computation unit 43 can compute Expression (28) by executing algorithm illustrated in FIG. 6, for example.

Note that the algorithm of the vectorial addition chain is determined on the basis of the addition chain of the exponent of each of the plurality of bases. A method of generating the algorithm of the vectorial addition chain is described in non-patent literature (Roberto M. Avanzi, etc., “Handbook of Elliptic and Hyperelliptic Curve Cryptography”, Chapman & Hall/CRC Taylor & Francis Group, 2006, PP. 157-159), for example.

Next, the cost of computing Expressions (28) and (29) is calculated. A cost of a square operation of an element on a 12-th extension field is expressed as Sₜ. A multiplication cost of the element on the 12-th extension field is expressed as M₁₂. In this case, moreover, an exponentiation cost of c with respect to the element on the 12-th extension field can be expressed as floor(log c)×Sₜ+{HW(c)−1}×M₁₂. In the expression, HW(c) denotes the signed Hamming weight of c. Note that a computation cost of an inverse element is 0.

Five square operations and nine multiplications are involved when Expression (28) is computed with the vectorial addition chain. Three exponentiation operations of c and five multiplications are involved when Expression (29) is computed. Accordingly, the computation cost of the exponentiation with {AΦₖ(p)/r} is expressed as Expression (30) below when the BN curve is used in the Optimal Ate pairing.

Cost_{—}1={3 floor(log c)+5}Sₜ+{3HW(c)+11}M₁₂ (30)

One can see from Expression (30) that the computation cost of {AΦₖ(p)/r} becomes smaller as the signed Hamming weight of the loop parameter c of the Miller function is smaller. The signed Hamming weight of the loop parameter c of the Miller function is set to the minimum value or the value close to the minimum value by the Miller function computation unit 20. Therefore, it can be said that the computation cost of {AΦₖ(p)/r} is small when the BN curve is used in the Optimal Ate pairing.

The final exponentiation unit 30 as described above performs computation of the expression including the exponentiation of the element on the k-th extension field by the loop parameter c of the Miller function (f^{c}). Therefore, the final exponentiation unit 30 can perform the exponentiation with {AΦₖ(p)/r} at a small cost.

Note that the exponent in Expression (28) is six times greater than the exponent Φₖ(p)/r used in the normal pairing computation. This six-fold multiplication corresponds to A of the exponent AΦₖ(p)/r computed in the third exponentiation unit 33. Accordingly, the final exponentiation unit 30 of the pairing computation apparatus 10 has the exponent that is A times greater (such as an integer of 2 or greater) than the exponent used in the normal pairing computation. The result of pairing computation with the A-fold exponent still satisfies the characteristic of pairing such as bilinearity and non-degeneracy. The pairing computation apparatus 10 can therefore be used in the pairing-based cryptography processing.

Freeman Curve

Next, there will be described an expression computed by the base calculation unit 42 and the vectorial addition chain computation unit 43 specifically when the Freeman curve is used in the Optimal Ate pairing.

The embedding degree of the Freeman curve is k=10, whereby the k-th cyclotomic polynomial Φₖ(p) is expressed as Expression (31) below.

Φ₁₀(p)=p⁴−p³+p²−p+1 (31)

Expression (31) is divided by “r” to obtain Expression (32) below.

$$\frac{{Φ}_{10} ( p )}{r} = \frac{{p}^{4} - {p}^{3} + {p}^{2} - p + 1}{r} \qquad ( 32 )$$

The p and r of the Freeman curve are represented by the polynomial expression of x as expressed in Expressions (14) and (15). Expressions (14) and (15) are substituted for Expression (32), which is then organized to be modified into Expression (33) below.

$$\frac{{Φ}_{10} ( p )}{r} = {λ}_{3} {p}^{3} + {λ}_{2} {p}^{2} + {λ}_{1} p + {λ}_{0} \qquad ( 33 )$$

In Expression (33), each of λ₀, λ₁, λ₂, and λ₃ is set as in Expression (34) below,

$$\{ \begin{matrix}{λ}_{3} = 1 \\ {λ}_{2} = 10 {x}^{2} + 5 x + 5 \\ {λ}_{1} = - 5 {x}^{2} - 5 x - 3 \\ {λ}_{0} = - 25 {x}^{3} - 15 {x}^{2} - 15 x - 2\end{matrix} \qquad ( 34 )$$

Here, the parameter c equals c=−5x−1 when the Freeman curve is used in the Optimal Ate pairing. Each of λ₀, λ₁, λ₂, and λ₃ in Expression (34) is then converted to an expression with the loop parameter c of the Miller function as a variable, as in Expression (35) below.

$$\{ \begin{matrix}{λ}_{3} = 1 \\ {λ}_{2} = ( 2 {c}^{2} - c + 22 ) / 5 \\ {λ}_{1} = ( - {c}^{3} + 3 c - 11 ) / 5 \\ {λ}_{0} = ( {c}^{3} + 12 c + 3 ) / 5\end{matrix} \qquad ( 35 )$$

In order for the exponent to have an integer value, each of λ₀, λ₁, λ₂, and λ₃ in Expression (35) is multiplied by 5. Then, there is obtained Expression (36) below in which the element f on the extension field is raised to the power of the expression using the five-fold λ₀, λ₁, λ₂, and λ₃.

$${f}^{5 \cdot \frac{{Φ}_{10} ( p )}{r}} = {y}_{0} \cdot {y}_{1}^{2} \cdot {y}_{2}^{3} \cdot {y}_{3}^{5} \cdot {y}_{4}^{11} \cdot {y}_{5}^{12} \cdot {y}_{6}^{22} \qquad ( 36 )$$

Each of y₀, y₁, y₂, y₃, y₄, y₅, and y₆ in Expression (36) is determined according to Expression (37) below.

$$\{ \begin{matrix}{y}_{0} = {f}^{{c}^{3}} / \{ {f}^{c} \cdot {( {f}^{{c}^{3}} )}^{p} \} \\ {y}_{1} = {( {f}^{{c}^{2}} )}^{{p}^{2}} \\ {y}_{2} = {( {f}^{c} )}^{p} \cdot f \\ {y}_{3} = {f}^{{p}^{3}} \\ {y}_{4} = 1 / {f}^{p} \\ {y}_{5} = {f}^{c} \\ {y}_{6} = {f}^{{p}^{2}}\end{matrix} \qquad ( 37 )$$

Each of the bases y₀, y₁, y₂, y₃, y₄, y₅, and y₆ has a value according to Expression (37) above when the Freeman curve is used in the Optimal Ate pairing. That is, when the Freeman curve is used in the Optimal Ate pairing, the base calculation unit 42 computes Expression (37) to output the bases y₀, y₁, y₂, y₃, y₄, y₅, and y₆. Note that Expression (37) includes exponentiation in which the element f is raised to the power of the loop parameter c of the Miller function.

Moreover, when the Freeman curve is used in the Optimal Ate pairing, the vectorial addition chain computation unit 43 performs computation of Expression (36) by using the vectorial addition chain.

Next, the cost of computing Expressions (36) and (37) is calculated. A cost of a square operation of an element on a 10-th extension field is expressed as S₁₀. A multiplication cost of the element on the 10-th extension field is expressed as M₁₀. In this case, moreover, an exponentiation cost of c with respect to the element on the 10-th extension field can be expressed as floor(log c)×S₁₀+{HW(c)−1}×M₁₀. Note that a computation cost of an inverse element is 0.

Three square operations and 10 multiplications are involved when Expression (36) is computed with the vectorial addition chain. Moreover, three exponentiation operations of c and three multiplications are involved when Expression (37) is computed. Accordingly, the computation cost of the exponentiation with the exponent {AΦₖ(p)/r} is expressed as Expression (38) below when the Freeman curve is used in the Optimal Ate pairing.

Cost_{—}2={3 floor(log c)+3}S₁₀+{3HW(c)+10}M₁₀ (38)

One can see from Expression (38) that the computation cost of {AΦₖ(p)/r} becomes smaller as the signed Hamming weight of the loop parameter c of the Miller function is smaller. The signed Hamming weight of the loop parameter c of the Miller function is set to the minimum value or the value close to the minimum value by the Miller function computation unit 20. Therefore, it can be said that the computation cost of {AΦₖ(p)/r} is small when the Freeman curve is used in the Optimal Ate pairing. As a result, the final exponentiation unit 30 can perform the exponentiation with {AΦₖ(p)/r} at a small cost when the Freeman curve is used in the Optimal Ate pairing as well.

Note that the exponent in Expression (36) is five times greater than the exponent Φₖ(p)/r used in the normal pairing computation. This five-fold multiplication corresponds to A of the exponent AΦₖ(p)/r computed in the third exponentiation unit 33.

First Variation

What is performed in Expressions (27) and (35) is the conversion of variables in λ₀, λ₁, λ₂, and λ₃ from x to c. Alternatively, the variables in λ₀, λ₁, λ₂, and λ₃ may be replaced from x to h.

Here, h is a value that is determined on the basis of expression h(c) with the loop parameter c of the Miller function as the variable and obtained by adding and/or subtracting an integer to/from c or multiplying and/or dividing c by an integer, for example.

For example, h may be a value obtained by dividing the loop parameter c of the Miller function by a divisor of the loop parameter c of the Miller function. Moreover, h may be a value obtained by multiplying the loop parameter c of the Miller function by 2^{l}, where l is an integer. Furthermore, h may be a value obtained by adding and/or subtracting the integer to/from the loop parameter c of the Miller function.

There will be described an example where h is the value obtained by dividing c by 2 when the BN curve is used. In this case, h is expressed by Expression (41) below.

h=3x+1 (41)

Each of λ₀, λ₁, λ₂, and λ₃ in Expression (26) is converted to an expression with h as the variable, as in Expression (42) below.

$$\{ \begin{matrix}{λ}_{3} = 1 \\ {λ}_{2} = \{ 2 {h}^{2} - 4 h + 5 \} / 3 \\ {λ}_{1} = \{ - 4 {h}^{3} + 6 {h}^{2} - 12 h + 13 \} / 3 \\ {λ}_{0} = \{ - 4 {h}^{3} + 2 {h}^{2} - 10 h + 6 \} / 3\end{matrix} \qquad ( 42 )$$

In order for the exponent to have an integer value, each of λ₀, λ₁, λ₂, and λ₃ in Expression (42) is multiplied by 3. Then, there is obtained Expression (43) below in which the element f on the extension field is raised to the power of the expression using the three-fold λ₀, λ₁, λ₂, and λ₃.

$${f}^{3 \cdot \frac{{Φ}_{12} ( p )}{r}} = {y}_{0}^{2} \cdot {y}_{1}^{3} \cdot {y}_{2}^{4} \cdot {y}_{3}^{5} \cdot {y}_{4}^{6} \cdot {y}_{5}^{10} \cdot {y}_{6}^{12} \cdot {y}_{7}^{13} \qquad ( 43 )$$

Each of y₀, y₁, y₂, y₃, y₄, y₅, y₆, and y₇ in expression (43) is determined according to expression (44) below.

$$\{ \begin{matrix}{y}_{0} = {( {f}^{{h}^{2}} )}^{{p}^{2}} \cdot {f}^{{h}^{2}} \\ {y}_{1} = {f}^{{p}^{3}} \\ {y}_{2} = 1 / \{ {( {f}^{h} )}^{{p}^{2}} \cdot {( {f}^{{h}^{3}} )}^{p} \cdot {f}^{{h}^{3}} \} \\ {y}_{3} = {f}^{{p}^{2}} \\ {y}_{4} = {( {f}^{{h}^{2}} )}^{p} \cdot f \\ {y}_{5} = 1 / {f}^{h} \\ {y}_{6} = 1 / {( {f}^{h} )}^{p} \\ {y}_{7} = {f}^{p}\end{matrix} \qquad ( 44 )$$

That is, when the BN curve is used in the Optimal Ate pairing, the base calculation unit 42 may perform compute Expression (44) including the exponentiation by the value h based on the loop parameter c of the Miller function and output the bases y₀, y₁, y₂, y₃, y₄, y₅, y₆, and y₇. In this case, the vectorial addition chain computation unit 43 computes Expression (43) by using the vectorial addition chain.

The cost of computing Expressions (43) and (44) is now calculated. Five square operations and 10 multiplications are involved when Expression (43) is computed with the vectorial addition chain. Moreover, three exponentiation operations of h and four multiplications are involved when Expression (44) is computed. As a result, the computation cost of the exponentiation with {3Φₖ(p)/r} is expressed as Expression (45) below.

Cost_{—}3={3 floor(log h)+5}Sₜ+{3HW(h)+11}M₁₂ (45)

Here, “Cost_{—}1” of Expression (30) is compared with “Cost_{—}3” of Expression (45). Where c=6x+2 and h=3x+1, there holds “floor(log c)={floor(log h)}+1” and “HW(c)=HW(h)”.

This gives “Cost_{—}1−Cost_{—}3=3Sₜ”. In other words, the final exponentiation unit 30 can compute exponentiation with {AΦₖ(p)/r} at a lower cost when h=3x+1 than when h=6x+2.

Second Variation

There will now be described an example where h is the value obtained by dividing c by 2^{l} (that is, the value obtained by multiplying c by 2^{-l}) when the BN curve is used. Note that l is an integer of 1 or greater. In this case, h is expressed by Expression (51) below.

h=(6x+2)/2^{l} (51)

Each of λ₀, λ₁, λ₂, and λ₃ in Expression (26) is converted to an expression with h as the variable, as in Expression (52) below.

$$\{ \begin{matrix}{λ}_{3} = 1 \\ {λ}_{2} = \{ {2}^{2 l - 1} {h}^{2} - {2}^{l + 1} h + 5 \} / 3 \\ {λ}_{1} = \{ - {2}^{3 l - 1} {h}^{3} + 3 \cdot {2}^{2 l - 1} {h}^{2} - 3 \cdot {2}^{l + 1} h + 13 \} / 3 \\ {λ}_{0} = \{ - {2}^{3 l - 1} {h}^{3} + {2}^{2 l - 1} {h}^{2} - 5 \cdot {2}^{l} h + 6 \} / 3\end{matrix} \qquad ( 52 )$$

In order for the exponent to have an integer value, each of λ₀, λ₁, λ₂, and λ₃ in Expression (52) is multiplied by 3. Then, there is obtained Expression (53) below in which the element f on the extension field is raised to the power of the expression using the three-fold λ₀, λ₁, λ₂, and λ₃.

$${f}^{3 \cdot \frac{{Φ}_{12} ( p )}{r}} = {y}_{0}^{3} \cdot {y}_{1}^{5} \cdot {y}_{2}^{6} \cdot {y}_{3}^{13} \cdot {y}_{4}^{{2}^{( l + 1 )}} \cdot {y}_{5}^{5 \cdot {2}^{l}} \cdot {y}_{6}^{3 \cdot {2}^{( l + 1 )}} \cdot {y}_{7}^{{2}^{( 2 l - 1 )}} \cdot {y}_{8}^{3 \cdot {2}^{( 2 l - 1 )}} \cdot {y}_{9}^{{2}^{( 3 l - 1 )}} \qquad ( 53 )$$

Each of y₀, y₁, y₂, y₃, y₄, y₅, y₆, y₇, y₈, and y₉ in Expression (53) is determined according to Expression (54) below.

$$\{ \begin{matrix}{y}_{0} = {f}^{{p}^{3}} \\ {y}_{1} = {f}^{{p}^{2}} \\ {y}_{2} = f \\ {y}_{3} = {f}^{p} \\ {y}_{4} = 1 / {{( {f}^{h} )}^{p}}^{2} \\ {y}_{5} = 1 / {f}^{h} \\ {y}_{6} = 1 / {( {f}^{h} )}^{p} \\ {y}_{7} = {( {f}^{{h}^{2}} )}^{{p}^{2}} \cdot {f}^{{h}^{2}} \\ {y}_{8} = {( {f}^{{h}^{2}} )}^{p} \\ {y}_{9} = 1 / \{ {( {f}^{{h}^{3}} )}^{p} \cdot {f}^{{h}^{3}} \}\end{matrix} \qquad ( 54 )$$

That is, when the BN curve is used in the Optimal Ate pairing, the base calculation unit 42 may compute Expression (54) including the exponentiation by the value h based on the loop parameter c of the Miller function and output the bases y₀, y₁, y₂, y₃, y₄, y₅, y₆, y₇, y₈, and y₉. In this case, the vectorial addition chain computation unit 43 computes Expression (53) by using the vectorial addition chain.

The cost of computing Expressions (53) and (54) when l=10 is now calculated. Twenty-eight square operations and 17 multiplications are involved when Expression (53) is computed with the vectorial addition chain. Moreover, three exponentiation operations of h and two multiplications are involved when Expression (54) is computed. As a result, the computation cost of the exponentiation with {3Φₖ(p)/r} is expressed as Expression (55) below.

Cost_{—}4={3 floor(log h)+28}Sₜ+{3HW(h)+16}M₁₂ (55)

Here, “Cost_{—}1” of Expression (30) is compared with “Cost_{—}4” of Expression (55). Where c=6x+2 and h=(6x+2)/2¹⁰, there holds “floor(log c)={floor (log h)}+10” and “HW(c)=HW(h)”.

This gives Cost_{—}1−Cost_{—}4=7Sₜ−5M₁₂. That is, the final exponentiation unit 30 can compute exponentiation with {AΦₖ(p)/r} at a lower cost when h=(6x+2)/2¹⁰ than when h=6x+2.

Third Variation

There will be described an example where h is the value obtained by subtracting 1 from c when the BN curve is used. In this case, h is expressed by Expression (61) below.

h=6x+1 (61)

Each of λ₀, λ₁, λ₂, and λ₃ in Expression (26) is converted to an expression with h as the variable, as in Expression (62) below.

$$\{ \begin{matrix}{λ}_{3} = 1 \\ {λ}_{2} = \{ {h}^{2} - 2 h + 7 \} / 6 \\ {λ}_{1} = \{ - {h}^{3} - 9 h + 16 \} / 6 \\ {λ}_{0} = \{ - {h}^{3} - 2 {h}^{2} - 11 h + 2 \} / 6\end{matrix} \qquad ( 62 )$$

In order for the exponent to have an integer value, each of λ₀, λ₁, λ₂, and λ₃ in Expression (62) is multiplied by 6. Then, there is obtained Expression (63) in which the element f on the extension field is raised to the power of the expression using the six-fold λ₀, λ₁, λ₂, and λ₃.

$${f}^{6 \cdot \frac{{Φ}_{12} ( p )}{r}} = {y}_{0} \cdot {y}_{1}^{2} \cdot {y}_{2}^{6} \cdot {y}_{3}^{7} \cdot {y}_{4}^{9} \cdot {y}_{5}^{11} \cdot {y}_{6}^{16} \qquad ( 63 )$$

Each of y₀, y₁, y₂, y₃, y₄, y₅, and y₆ in Expression (63) is determined according to Expression (64) below.

$$\{ \begin{matrix}{y}_{0} = {( {f}^{{h}^{2}} )}^{{p}^{2}} / \{ {( {f}^{{h}^{3}} )}^{p} \cdot {f}^{{h}^{3}} \} \\ {y}_{1} = f / \{ {( {f}^{h} )}^{{p}^{2}} \cdot {f}^{{h}^{2}} \} \\ {y}_{2} = {f}^{{p}^{3}} \\ {y}_{3} = {f}^{{p}^{2}} \\ {y}_{4} = 1 / {( {f}^{h} )}^{p} \\ {y}_{5} = 1 / {f}^{h} \\ {y}_{6} = {f}^{p}\end{matrix} \qquad ( 64 )$$

That is, when the BN curve is used in the Optimal Ate pairing, the base calculation unit 42 may compute Expression (64) including the exponentiation by the value h based on the loop parameter c of the Miller function and output the bases y₀, y₁, y₂, y₃, y₄, y₅, and y₆. In this case, the vectorial addition chain computation unit 43 computes Expression (63) by using the vectorial addition chain.

The cost of computing Expressions (63) and (64) is now calculated. Two square operations and 11 multiplications are involved when Expression (63) is computed with the vectorial addition chain. Moreover, three exponentiation operations of h and four multiplications are involved when Expression (64) is computed. As a result, the computation cost of the exponentiation with {6Φₖ(p)/r} is expressed as Expression (65) below.

Cost_{—}5={3 floor(log h)+2}Sₜ+{3HW(h)+12}M₁₂ (65)

Here, “Cost_{—}1” of Expression (30) is compared with “Cost_{—}5” of Expression (65). Where c=6x+2 and h=6x+1, there holds “floor(log c)=floor(log h)” and “HW(c)=HW(h)−1”.

This gives Cost_{—}1−Cost_{—}5=3Sₜ−4M₁₂. In other words, the final exponentiation unit 30 can compute exponentiation with {AΦₖ(p)/r} at a smaller cost compared to a method in the related art when h=6x+1 although the cost is greater than the case where h=6x+2.

According to the pairing computation apparatus 10 of the present embodiment as described above, the final exponentiation unit 30 computes the expression including the exponentiation (f^{h}) in which the element on the k-th extension field is raised to the power of the value h determined on the basis of the loop parameter c of the Miller function. As a result, the pairing computation apparatus 10 can decrease the cost of computing the Miller function and the cost of computing the final exponentiation by decreasing the signed Hamming weight of the loop parameter c of the Miller function.

Hardware Configuration

FIG. 7 is a diagram illustrating an example of a hardware configuration of the pairing computation apparatus 10 according to an embodiment. The pairing computation apparatus 10 according to the embodiment includes a control device such as a CPU 101, a storage device such as a ROM (Read Only Memory) 102 and a RAM (Random Access Memory) 103, a communication I/F 104 which performs communication by connecting to a network, and a bus which connects each of these devices.

A program executed by the pairing computation apparatus 10 according to the embodiment is incorporated in the ROM 102 or the like in advance to be provided as a computer program product.

The program executed by the pairing computation apparatus 10 according to the embodiment may be configured to be stored in a computer-readable storage medium in an installable format or executable file format and provided as a computer program product, the recording medium including a CD-ROM (Compact Disk Read Only Memory), a flexible disk (FD), a CD-R (Compact Disk Recordable), or a DVD (Digital Versatile Disk).

Moreover, the program executed by the pairing computation apparatus 10 according to the embodiment may be configured to be stored on a computer connected to a network such as the Internet, and downloaded via the network for provision. The program executed by the pairing computation apparatus 10 according to the embodiment may also be configured to be provided or distributed via the network such as the Internet.

The program executed by the pairing computation apparatus 10 according to the embodiment can cause a computer to function as each unit (the Miller function computation unit 20 and the final exponentiation unit 30) of the pairing computation apparatus 10 described above. Note that a part or all of each of these units may be configured by hardware. The computer can execute the program when the CPU 101 reads the program from a computer-readable recording medium onto a main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pairing computation apparatus for receiving two points on a predetermined elliptic curve defined on a finite field, and outputting a pairing value that is an element on an extension field of the finite field, the apparatus comprising:
a Miller function computation unit configured to compute a Miller function based on a predetermined pairing method; and
a final exponentiation unit configured to perform computation including raising the element on the extension field to the power of a value determined on the basis of a loop parameter of the Miller function.

2. The apparatus according to claim 1, wherein the value determined on the basis of the loop parameter of the Miller function is the loop parameter of the Miller function.

3. The apparatus according to claim 1, wherein the value determined on the basis of the loop parameter of the Miller function is a value obtained by dividing the loop parameter of the Miller function by a divisor of the loop parameter of the Miller function.

4. The apparatus according to claim 1, wherein the value determined on the basis of the loop parameter of the Miller function is a value obtained by multiplying the loop parameter of the Miller function by 2^{l}, where l is an integer.

5. The apparatus according to claim 1, wherein the value determined on the basis of the loop parameter of the Miller function is a value obtained by adding and/or subtracting an integer to/from the loop parameter of the Miller function.

6. The apparatus according to claim 1, wherein the loop parameter of the Miller function is set to have a minimum Hamming weight when the loop parameter is represented by binary in a signed binary expansion.

7. The apparatus according to claim 1, wherein the final exponentiation unit is configured to perform exponentiation that raises a computation result obtained by the Miller function computation unit to the power of (p^{k/2}−1)·{(p^{k/2}+1)/Φₖ(p)}·{AΦₖ(p)/r},
where p is a characteristic of the finite field, r is an order of the predetermined elliptic curve defined on the finite field, the received two points are represented as points P and Q on the predetermined elliptic curve, the paring value to be output is an element on a k-th extension field of the finite field, Φₖ(p) is a k-th cyclotomic polynomial, and A is an integer of 2 or greater.

8. The apparatus according to claim 7, wherein
the final exponentiation unit includes an exponentiation unit configured to perform exponentiation with the {AΦₖ(p)/r} as an exponent, and
the exponentiation unit includes
a base calculator configured to calculate a plurality of bases by a predetermined expression including the exponentiation with the loop parameter of the Miller function as an exponent, and
a vectorial addition chain computation unit configured to use a vectorial addition chain to compute an expression that values, each obtained by raising the respective bases to the power of an integer of 1 or greater, are multiplied together.

9. The apparatus according to claim 1, wherein the Miller function computation unit is configured to compute the Miller function based on an Optimal Ate pairing.

10. The apparatus according to claim 1, wherein the predetermined elliptic curve is a BN curve.

11. The apparatus according to claim 8, wherein
the Miller function computation unit is configured to compute the Miller function based on an Optimal Ate pairing,
the predetermined elliptic curve is a BN curve,
the BN curve has the embedding degree k of the k-th extension field=12, the characteristic p equal to 36x⁴+36x³+24x²+6x+1, and the order r equal to 36x⁴+36x³+18x²+6x+1, and
the loop parameter c of the Miller function equals 6x+2.

12. The apparatus according to claim 11, wherein the Miller function computation unit is configured to, when the number of digits of the binary representation of the order r corresponds to any value in column ceil(log r) in the following table, set the loop parameter of the Miller function to a corresponding value in column c in the same table,

| ceil(log r) | c |
|---|---|
| 224 | −2⁵⁷ −2⁵² +2³ |
| 226 | 2⁵⁷ +2⁵⁶ −2⁵⁰ |
| 226 | 2⁵⁸ −2⁵⁶ −2⁵⁰ |
| 227 | −2⁵⁸ −2³¹ −2⁴ |
| 227 | −2⁵⁸ +2⁵⁴ −2³⁰ |
| 227 | −2⁵⁸ +2⁴ +2 |
| 231 | 2⁵⁹ +2² +2 |
| 231 | 2⁵⁹ +2³ −2 |
| 231 | 2⁵⁹ −2⁵¹ −2¹⁸ |
| 235 | −2⁶⁰ +2²³ −2⁷ |
| 239 | −2⁶¹ −2²⁶ +2³ |
| 239 | 2⁶¹ +2³³ −2 |
| 239 | 2⁶¹ −2⁵³ +2¹¹ |
| 247 | 2⁶³ −2²⁴ +2⁶ |
| 247 | −2⁶³ +2⁵³ −2¹⁶ |
| 247 | −2⁶³ +2²⁵ +2¹⁵ |
| 251 | 2⁶⁴ +2³⁹ +2¹⁵ |
| 255 | −2⁶⁵ −2⁴⁴ −2²⁴ |
| 255 | 2⁶⁵ −2³⁸ −2²³ |
| 255 | 2⁶⁵ −2⁵⁶ −2⁴¹ |
| 259 | 2⁶⁶ +2²⁷ +2¹⁹ |
| 259 | −2⁶⁶ −2⁵⁴ −2³⁵ |
| 259 | −2⁶⁶ +2²⁶ −2⁶ |
| 259 | −2⁶⁶ +2⁵⁴ +2²⁵ |
| 259 | −2⁶⁶ +2⁶³ +2¹⁰ |
| 263 | 2⁶⁷ +2¹² −2⁶ |
| 267 | −2⁶⁸ −2⁵² +2¹⁶ |
| 267 | 2⁶⁸ −2²⁴ +2⁷ |
| 271 | 2⁶⁹ +2¹² +2⁷ |
| 271 | 2⁶⁹ −2²⁷ +2¹¹ |
| 271 | −2⁶⁹ +2⁵⁷ −2³⁴ |
| 272 | 2⁶⁹ +2⁶⁶ −2²⁶ |
| 275 | −2⁷⁰ −2⁵⁷ −2²⁸ |
| 275 | 2⁷⁰ +2⁵⁹ −2⁵⁴ |
| 279 | 2⁷¹ −2²³ +2¹⁵ |
| 283 | 2⁷² −2⁵⁸ +2²⁵ |
| 283 | 2⁷² −2²⁰ −2¹² |
| 283 | −2⁷² +2³⁷ +2² |
| 287 | −2⁷³ −2⁴⁴ −2²⁰ |
| 287 | 2⁷³ −2⁵⁴ +2⁴² |
| 287 | −2⁷³ +2⁶¹ −2¹⁰. |

13. The apparatus according to claim 1, wherein the predetermined elliptic curve is a Freeman curve.

14. The apparatus according to claim 8, wherein
the Miller function computation unit is configured to compute the Miller function based on an Optimal Ate pairing,
the predetermined elliptic curve is a Freeman curve,
the Freeman curve has the embedding degree k of the k-th extension field=10, the characteristic p equal to 25x⁴+25x³+25x²+10x+3, and the order r equal to 25x⁴+25x³+15x²+5x+1, and
the loop parameter c of the Miller function equals −5x−1.

15. The apparatus according to claim 14, wherein the Miller function computation unit is configured to, when the number of digits of the binary representation of the order r corresponds to any value in column ceil(log r) in the following table, set the loop parameter of the Miller function to a corresponding value in column c in the same table,

| ceil(log r) | c |
|---|---|
| 224 | −2⁵⁷ −2¹⁸ +2⁸ −1 |
| 224 | −2⁵⁷ +2⁵¹ +2³⁷ +1 |
| 228 | 2⁵⁸ +2²⁶ +2⁵ −1 |
| 228 | −2⁵⁸ −2⁴⁵ +2⁴⁰ −1 |
| 228 | 2⁵⁸ −2³¹ −2⁸ −1 |
| 232 | −2⁵⁹ −2⁴⁷ −2¹⁴ −1 |
| 232 | 2⁵⁹ +2⁵⁴ −2³⁸ +1 |
| 232 | −2⁵⁹ +2¹³ +2⁴ −1 |
| 240 | 2⁶¹ +2⁴³ −2³³ +1 |
| 240 | −2⁶¹ +2⁵³ +2³⁵ +1 |
| 244 | 2⁶² +2³⁰ +2⁵ −1 |
| 260 | −2⁶⁶ −2⁶¹ −2³⁶ +1 |
| 268 | −2⁶⁸ −2²¹ −2⁶ +1 |
| 268 | −2⁶⁸ +2³³ −2²³ +1 |
| 268 | −2⁶⁸ +2⁵⁷ −2²⁷ +1 |
| 276 | 2⁷⁰ +2³⁷ +2⁵ +1 |
| 288 | 2⁷³ +2⁵⁰ +2³⁴ −1 |
| 288 | −2⁷³ −2⁶⁶ −2¹⁶ +1 |
| 288 | −2⁷³ +2⁶⁰ −2³⁴ −1. |

16. A pairing computation method for receiving two points on a predetermined elliptic curve defined on a finite field, and outputting a pairing value that is an element on an extension field of the finite field, the method comprising:
computing a Miller function based on a predetermined pairing method; and
performing computation including raising the element on the extension field to the power of a value determined on the basis of a loop parameter of the Miller function.

17. A computer program product comprising a computer-readable medium containing a program executed by a computer for performing pairing computation that receives two points on a predetermined elliptic curve defined on a finite field, and outputs a pairing value that is an element on an extension field of the finite field, the program causing the computer to execute:
computing a Miller function based on a predetermined pairing method; and
performing computation including raising the element on the extension field to the power of a value determined on the basis of a loop parameter of the Miller function.

18. A pairing computation apparatus for receiving two points on a BN curve with an order r defined on a finite field with a characteristic p and outputting a pairing value that is an element on a k-th extension field of the finite field, the apparatus comprising:
a Miller function computation unit configured to compute a Miller function based on an Optimal Ate pairing; and
a final exponentiation unit configured to perform exponentiation on a computation result obtained by the Miller function computation unit, wherein
the BN curve has the embedding degree k of the k-th extension field=12, the characteristic p equal to 36x⁴+36x³+24x²+6x+1, and the order r equal to 36x⁴+36x³+18x²+6x+1, and
the Miller function computation unit is configured to, when the number of digits of the binary representation of the order r corresponds to any value in column ceil(log r) in the following table, set a loop parameter of the Miller function to a corresponding value in column c in the same table,

| ceil(log r ) | c |
|---|---|
| 224 | −2⁵⁷ −2⁵² +2³ |
| 226 | 2⁵⁷ +2⁵⁶ −2⁵⁰ |
| 226 | 2⁵⁸ −2⁵⁶ −2⁵⁰ |
| 227 | −2⁵⁸ −2³¹ −2⁴ |
| 227 | −2⁵⁸ +2⁵⁴ −2³⁰ |
| 227 | −2⁵⁸ +2⁴ +2 |
| 231 | 2⁵⁹ +2² +2 |
| 231 | 2⁵⁹ +2³ −2 |
| 231 | 2⁵⁹ −2⁵¹ −2¹⁸ |
| 235 | −2⁶⁰ +2²³ −2⁷ |
| 239 | −2⁶¹ −2²⁶ +2³ |
| 239 | 2⁶¹ +2³³ −2 |
| 239 | 2⁶¹ −2⁵³ +2¹¹ |
| 247 | 2⁶³ −2²⁴ +2⁶ |
| 247 | −2⁶³ +2⁵³ −2¹⁶ |
| 247 | −2⁶³ +2²⁵ +2¹⁵ |
| 251 | 2⁶⁴ +2³⁹ +2¹⁵ |
| 255 | −2⁶⁵ −2⁴⁴ −2²⁴ |
| 255 | 2⁶⁵ −2³⁸ −2²³ |
| 255 | 2⁶⁵ −2⁵⁶ −2⁴¹ |
| 259 | 2⁶⁶ +2²⁷ +2¹⁹ |
| 259 | −2⁶⁶ −2⁵⁴ −2³⁵ |
| 259 | −2⁶⁶ +2²⁶ −2⁶ |
| 259 | −2⁶⁶ +2⁵⁴ +2²⁵ |
| 259 | −2⁶⁶ +2⁶³ +2¹⁰ |
| 263 | 2⁶⁷ +2¹² −2⁶ |
| 267 | −2⁶⁸ −2⁵² +2¹⁶ |
| 267 | 2⁶⁸ −2²⁴ +2⁷ |
| 271 | 2⁶⁹ +2¹² +2⁷ |
| 271 | 2⁶⁹ −2²⁷ +2¹¹ |
| 271 | −2⁶⁹ +2⁵⁷ −2³⁴ |
| 272 | 2⁶⁹ +2⁶⁶ −2²⁶ |
| 275 | −2⁷⁰ −2⁵⁷ −2²⁸ |
| 275 | 2⁷⁰ +2⁵⁹ −2⁵⁴ |
| 279 | 2⁷¹ −2²³ +2¹⁵ |
| 283 | 2⁷² −2⁵⁸ +2²⁵ |
| 283 | 2⁷² −2²⁰ −2¹² |
| 283 | −2⁷² +2³⁷ +2² |
| 287 | −2⁷³ −2⁴⁴ −2²⁰ |
| 287 | 2⁷³ −2⁵⁴ +2⁴² |
| 287 | −2⁷³ +2⁶¹ −2¹⁰. |

19. A pairing computation apparatus for receiving two points on a Freeman curve with an order r defined on a finite field with a characteristic p and outputting a pairing value that is an element on a k-th extension field of the finite field, the apparatus comprising:
a Miller function computation unit configured to compute a Miller function based on an Optimal Ate pairing; and
a final exponentiation unit configured to perform exponentiation on a computation result obtained by the Miller function computation unit, wherein
the Freeman curve has the embedding degree k of the k-th extension field=10, the characteristic p equal to 25x⁴+25x³+25x²+10x+3, and the order r equal to 25x⁴+25x³+15x²+5x+1, and
the Miller function computation unit is configured to, when the number of digits of the binary representation of the order r corresponds to any value in column ceil(log r) in the following table, set the loop parameter of the Miller function to a corresponding value in column c in the same table,

| ceil(log r) | c |
|---|---|
| 224 | −2⁵⁷ −2¹⁸ +2⁸ −1 |
| 224 | −2⁵⁷ +2⁵¹ +2³⁷ +1 |
| 228 | 2⁵⁸ +2²⁶ +2⁵ −1 |
| 228 | −2⁵⁸ −2⁴⁵ +2⁴⁰ −1 |
| 228 | 2⁵⁸ −2³¹ −2⁸ −1 |
| 232 | −2⁵⁹ −2⁴⁷ −2¹⁴ −1 |
| 232 | 2⁵⁹ +2⁵⁴ −2³⁸ +1 |
| 232 | −2⁵⁹ +2¹³ +2⁴ −1 |
| 240 | 2⁶¹ +2⁴³ −2³³ +1 |
| 240 | −2⁶¹ +2⁵³ +2³⁵ +1 |
| 244 | 2⁶² +2³⁰ +2⁵ −1 |
| 260 | −2⁶⁶ −2⁶¹ −2³⁶ +1 |
| 268 | −2⁶⁸ −2²¹ −2⁶ +1 |
| 268 | −2⁶⁸ +2³³ −2²³ +1 |
| 268 | −2⁶⁸ +2⁵⁷ −2²⁷ +1 |
| 276 | 2⁷⁰ +2³⁷ +2⁵ +1 |
| 288 | 2⁷³ +2⁵⁰ +2³⁴ −1 |
| 288 | −2⁷³ −2⁶⁶ −2¹⁶ +1 |
| 288 | −2⁷³ +2⁶⁰ −2³⁴ −1. |
